(19) United States
(12) Patent Application Publication
(10) Pub. No.: US 2024/0285069 A1
(43) Pub. Date: Aug. 29, 2024

(54) Adjustable Hinge for a Delivery Cart and Method for Constructing the Same

(71) Applicant: Cambro Manufacturing Company, Huntington Beach, CA (US)

(72) Inventor: Jeff Nicholson, Long Beach, CA (US)

(21) Appl. No.: 18/175,256

(22) Filed: Feb. 27, 2023

(51) Int. Cl. A47B 31/00; B62B 3/00; B62B 3/02; E05D 3/02; E05D 7/04; E05D 7/10

(52) U.S. Cl. CPC A47B 31/00; B62B 3/004; B62B 3/005; B62B 3/02; E05D 3/02; E05D 7/04; E05D 7/1044; A47B 2031/002; A47B 2031/003; B62B 2202/67; E05C 1/006; E05C 1/04; E05D 2007/0484; E05Y 2900/531

(57) ABSTRACT

A food service cart comprising a removable and adjustable hinge which accommodates for the normal inconsistences that are inherent with the rotational molding process. The hinge comprises a bore which is defined off-center relative to its longitudinal axis, allowing the bore to be selectively adjusted relative to a side panel and a door of the food service cart and provide a proper alignment there between. A plurality of facets disposed on the hinge ensure that it does not further rotate as the door is being rotated relative to the side panel. The food service cart also includes an expandable end table which forms a flush service with a side panel of the cart when in a collapsed or contracted configuration. A plurality of tray supports are disposed in the food service cart along with a flume defined therein which assists in the transfer of heat through the food service cart.

### BACKGROUND

### Field of the Technology

The invention relates to the field of mobile delivery carts and methods for constructing the same, specifically a mobile delivery cart which allows for variations present during the fabrication process.

### Description of the Prior Art

The food service industry, hospitals, and schools have long used mobile carts for accommodating cafeteria-style trays and other items used to serve food or other comestible goods. Typically, many of these carts comprise an interior cabinet which comprises a frame or a plurality of shelves for accommodating a number of trays thereon. Many carts further comprise a heating and/or cooling element such as a refrigerator or the like for maintaining the food stuffs at a desired temperature. Additionally, many carts traditionally comprise a plurality of casters or wheels which allow the cart to be moved or rolled to and from multiple locations.

Most carts used in schools or hospitals are made from plastic or plastic composites and are made using a technique known as rotational molding which is a well-known fabrication method. Typically, a shot of material is inserted into a mold which is then heated as it is rotated about at least one axis. As the mold is heated and rotated, the material spreads and fills every aspect and contour within the mold, producing a finished product dictated by the mold itself. Using rotational molding, everything from cooking utensils to storage containers can be quickly and cheaply made on an industrial scale.

However, a drawback commonly associated with rotational molding production is that due to small differences in pressure, temperature, and material purity, it is often difficult to maintain universal or consistent production between each piece that is made. This is particularly true when small or intricate detail is required within the product. The problem of inconsistent production can often be frustrating to manufacturers, however this problem is made noticeably worse when rotationally molded products require several different parts as non-uniform components may render the product more difficult to use or even worthless.

For example, as applied to rotationally molded mobile serving carts, many current designs require a rotationally molded door to be coupled to its frontal façade. However due to production inconsistencies, a rotationally molded door may be too large or misshapen and not always fit within the frame of the serving cart it was designed for in the exact manner as was intended. Production inconsistencies not only make assembly of the final product more difficult to assemble, but they may even make components of the mobile serving cart inappropriate for its intended purpose, thereby rendering the component worthless. This common problem decreases efficiency and increases the cost of production which in turn increases the costs for consumers interested in purchasing the serving cart.

What is needed is a mobile delivery cart which is not only easy to use, convenient, and efficient in a variety of different settings, but which is also capable of being manufactured while avoiding the known drawbacks associated with rotational molding techniques.

### BRIEF SUMMARY

The current invention provides a food service cart which includes at least one side panel, at least one door removably coupled to the at least one side panel, and a removable hinge disposed between the at least one side panel and the at least one door. The hinge itself preferably includes a longitudinal length that is defined by a plurality of facets and a bore that is defined through the longitudinal length of the hinge which is off-center relative to a longitudinal axis of the hinge.

In one embodiment, the hinge is rotatable relative to the at least one door and the at least one side panel.

In a further embodiment, the hinge comprises a top surface and a bottom surface joined to the top surface by a body, wherein the body comprises a plurality of facets that are defined around an outer circumference of the body.

In one embodiment, the bore defined through the longitudinal length of the hinge is specifically defined through a longitudinal length of the body.

In a separate embodiment, a plurality of bevels are disposed around the outer circumference of the body, wherein at least one of the plurality of bevels is disposed between at least two of the plurality of facets.

In yet another embodiment, the plurality of facets are specifically disposed along the entire longitudinal length of the body.

In some embodiments, the bore is configured to accommodate a hinge pin therein.

In a related embodiment, the food service cart also includes an expandable end table that is coupled to the at least one side panel, wherein the end table further forms a flush surface with the at least one side panel when the end table is in a contracted position. Here, the end table may also include a first bracket and an adjustable prop rod coupled to the first bracket. The prop rod may be further configured to removably couple to a second bracket disposed on the at least one side panel. Additionally, the end table may also include a rod indentation that is defined in a bottom surface of the end table and a bracket cutout that is defined in the bottom surface of the end table. Preferably, the rod indentation is configured to accommodate the longitudinal length of the prop rod, while the bracket cutout is configured to accommodate the second bracket disposed on the at least one side panel. In a related embodiment, the at least one side panel of the food service cart comprises a recess that is configured to accommodate a thickness of the end table in order to form the flush surface. In yet another related embodiment, the at least one door is configured to open to a maximum of 270 degrees relative to a closed configuration when the end table is in the contracted position, and to a maximum of 190 degrees relative to the closed configuration when the end table is in an expanded configuration.

In another embodiment, the food service cart also includes a first magnet that is disposed on the at least one door and a second that is disposed on the at least one side panel. The first magnet engages with the second magnet when the at least one door is disposed adjacent to the at least one side panel.

In a further embodiment, the food service cart has an internal volume that is subdivided into a plurality of parts by a dividing wall disposed therein. Here, a plurality of tray supports may also be disposed on the dividing wall and on an inside surface of the at least one side panel. Additionally, each of the plurality of parts of the internal volume includes a flume defined therein.

The current invention further provides a method for constructing a food service cart. The method includes providing at least one side panel and at least one door, disposing an adjustable hinge between the at least one side panel and the at least one door, and then adjusting a relative position of the hinge between the at least one side panel and the at least one door. The at least one door is then coupled to the at least one side panel. Preferably, adjusting the relative position of the hinge between the at least one side panel and the least one door includes adjusting a relative position of a bore that is defined through a longitudinal length of the hinge until a vertical alignment between the at least one side panel and the at least one door is obtained.

In one embodiment, adjusting the relative position of the hinge between the at least one side panel and the least one door specifically includes rotating the hinge relative to the at least one side panel and the at least one door.

In another embodiment, the method also includes preventing further movement between the hinge and either the at least one side panel or the at least one door after the at least one door has been coupled to the at least one side panel. Specifically, preventing further movement between the hinge and either the at least one side panel or the at least one door after the at least one door has been coupled to the at least one side panel includes applying a plurality of facets disposed on the hinge to an internal surface of the at least one side panel.

In yet another embodiment, disposing the adjustable hinge between the at least one side panel and the at least one door specifically includes inserting the hinge into a cavity that is defined within the at least one side panel. Here, adjusting the relative position of the bore defined through a longitudinal length of the hinge preferably includes changing the position of the bore relative to an internal surface of the cavity.

In a further embodiment, providing at least one side panel and at least one door specifically includes rotationally molding both the at least one side panel and the at least one door.

In one embodiment, coupling the at least one door to the at least one side panel specifically includes inserting the at least one door into the bore defined in the hinge.

In another embodiment, the method also includes providing at least one expandable end table that is coupled to the at least one side panel, a plurality of tray supports that are within an internal volume of the food service cart, and a flume that is defined within the internal volume of the food service cart.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1A is a perspective view of the rotationally molded cart of the current invention.

FIG. 1B is a frontal view of the rotationally molded cart seen in FIG. 1A.

FIG. 1C is a right lateral view of the rotationally molded cart seen in FIG. 1A.

FIG. 1D is a bottom view of the rotationally molded cart seen in FIG. 1A.

FIG. 2A is a perspective view of the rotationally molded cart seen in FIG. 1A when a set of doors and a set of end tables are in a closed configuration.

FIG. 2B is a frontal view of the rotationally molded cart seen in FIG. 2A.

FIG. 2C is a left lateral view of the rotationally molded cart seen in FIG. 2A.

FIG. 3 is a top view of the rotationally molded cart seen in FIG. 2A.

FIG. 4 is a perspective view of the rotationally molded cart seen in FIG. 1A when the doors are in an open configuration, including wherein at least one of the doors is in a maximum open position.

FIG. 5 is a perspective view of the rotationally molded cart seen in FIG. 4 when both doors are in a maximum open position and illustrating the eternal components of the cart.

FIG. 6 is a planar cross sectional view of the rotationally molded cart seen in FIG. 1A.

FIG. 7 is a magnified frontal view of a dividing wall disposed within the rotationally molded cart when the doors of the cart are in an open configuration.

FIG. 8 is a magnified frontal view of the dividing wall disposed within the rotationally molded cart seen in FIG. 7 when one of the doors of the cart is in a closed configuration.

FIG. 9 is a magnified rear view of the dividing wall disposed within the rotationally molded cart seen in FIG. 7 when the doors of the cart are in a closed configuration.

FIG. 10A is a perspective view of an adjustable hinge provided by the current invention.

FIG. 10B is a top down view of the adjustable hinge seen in FIG. 10A.

FIG. 11 is a magnified frontal cross sectional view of the rotationally molded cart illustrating the interaction of the adjustable hinge seen in FIGS. 10A and 10B with the doors of the cart.

FIG. 12A is a cross sectional illustration of the door of the rotationally molded cart being aligned with the adjustable hinge seen in FIG. 10A when a bore defined in the adjustable hinge is misaligned with a hinge pin disposed within a portion of the door.

FIG. 12B is top down view of the adjustable hinge and hinge pin seen in FIG. 12A, the hinge pin being represented by a broken line.

FIG. 13A is a cross sectional illustration of the door of the rotationally molded cart being aligned with the adjustable hinge seen in FIG. 10A when a bore defined in the adjustable hinge is correctly aligned with a hinge pin disposed within a portion of the door.

FIG. 13B is top down view of the adjustable hinge and hinge pin seen in FIG. 13A, the hinge pin being represented by a broken line.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

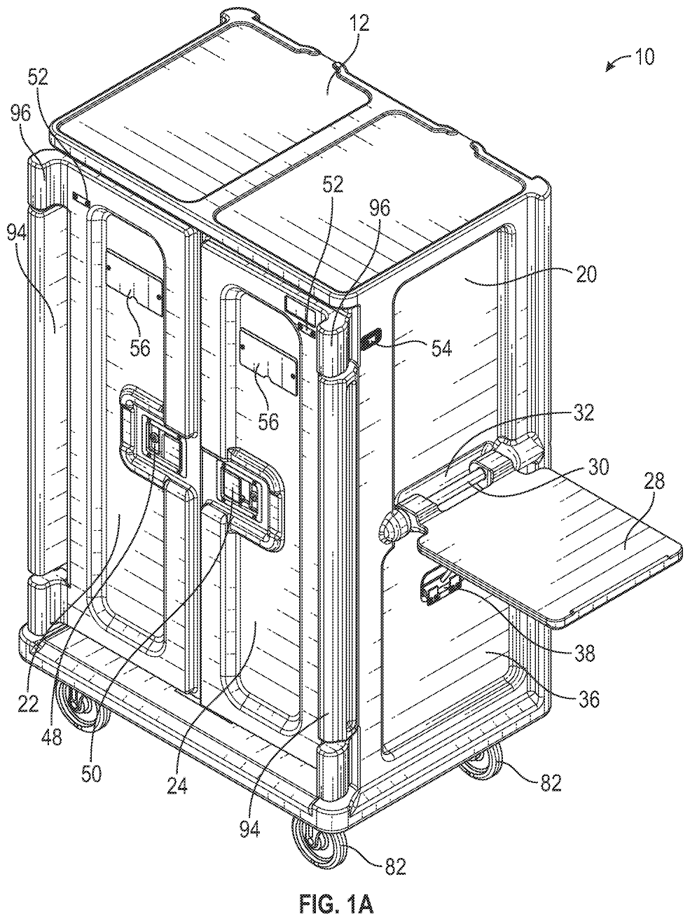

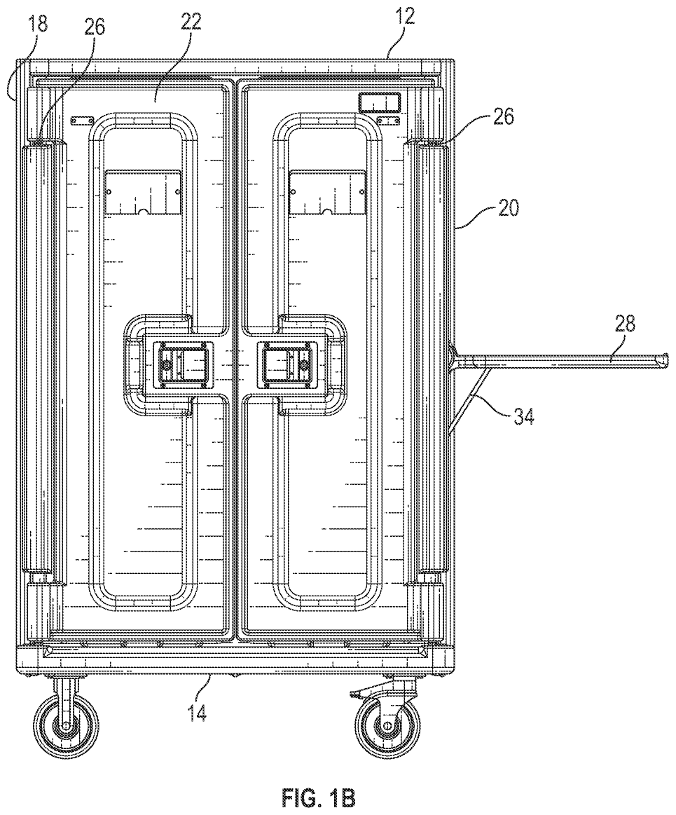

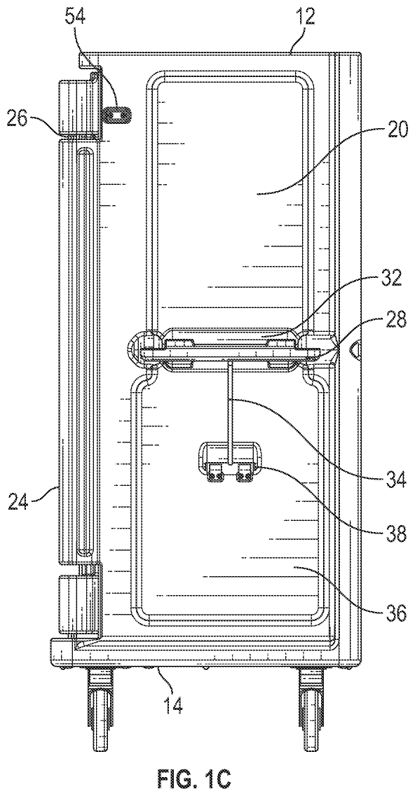

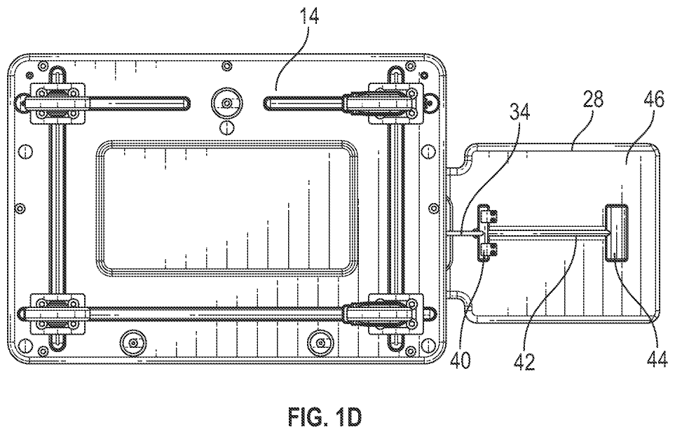

Greater understanding of the mobile delivery cart may be had by turning to FIG. 1A-1C which generally denote the mobile delivery cart with reference numeral 10. The cart 10 is substantially box or rectangular in shape and includes a top surface 12, a bottom surface 14, and a pair of side panels 18, 20 extending there between. Also disposed between the top surface 12 and the bottom surface 14 is a rear surface 16 which forms the back portion of the cart 10. The side panels 18, 20 are disposed vertically parallel relative to each other between the top surface 12 and the bottom surface 14 which are in turn disposed horizontally parallel relative to each other. Disposed on a front portion of the cart 10 are a pair doors 22, 24, namely a first door 22 coupled to a first side panel 18 and a second door 24 coupled to a second side panel 20.

In a preferred embodiment, the first and second doors 22, 24 rotate or pivot about at least one removable hinge 26 disposed between each of the respective doors 22, 24 and corresponding side panels 18, 20. More specifically, the first side panel 18 and the second side panel 20 each comprise a hinge column 94 disposed or integrally coupled to a forward or front facing edge, while each door 22, 24 comprises an upper hinge housing 96. Each hinge column 94 and upper hinge housing 96 comprises a bore or cavity defined through at least a portion of their respective longitudinal lengths for accommodating a hinge 26 therein.

The first and second doors 22, 24 as well as the main structural components of the cart 10 including but not limited to the top surface 12, bottom surface 14, rear surface 16, and the side panels 18, 20 are each comprised of plastic or plastic composites and are preferably manufactured using a rotational molding process. Each structural component comprises a thickness with a relatively hollow internal volume which allows the cart 10 to be relatively lightweight while still being thermal insulating for any food items that are stored within the cart 10.

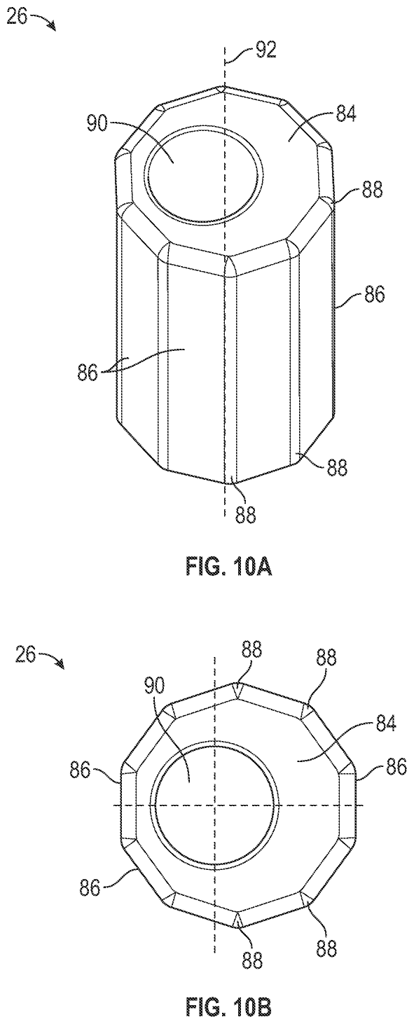

Greater detail of the hinges 26 disposed in the cart 10 may be had by turning to FIGS. 10A and 10B. Each hinge 26 comprises a top surface 84 and a bottom surface (not visible) joined together by a longitudinal body 85 comprising a plurality of facets 86. Each of the plurality of facets 86 comprises at least one beveled surface 88 which provides a transitional or intermediate region between each longitudinal edge of each facet 86 and an adjacent longitudinal edge of an adjacent or proximal facet 86. Defined through the longitudinal length of the hinge 26 is a bore 90 which is preferably defined or disposed off-center or off set relative to the longitudinal axis 92 of the hinge 26. In one preferred embodiment, and as best seen in FIG. 10B, the hinge 26 comprises at least ten facets 86 thereby providing the hinge 26 with a substantially decagonal cross section. However, it should be explicitly noted that in additional embodiments, the hinge 26 may comprise fewer or additional facets other from what is explicitly shown. For example, in alternative embodiments, the hinge 26 may comprise six, eight, or twelve facets, thereby providing the hinge 26 with a hexagonal, octagonal, or dodecagonal cross section, respectively. The hinge 26 is preferably comprised of rubber, plastic, or plastic composites, however other materials such a metal or wood may also be used.

Because the hinge 26 comprises a plurality of facets 86, the hinge 26 may be used to compensate or correct errors or deficiencies that are inherent with the rotational molding process. More specifically, when the doors 22, 24 and the hinge column 94 portions of the side panels 18, 20 of the cart 10 are manufactured via a rotational molding method, there are often slight inconsistencies which render proper vertical alignment between the upper and hinge housings 96, 98 with a corresponding hinge column 94 difficult. In other words, if a traditional hinge pin as is known in the art is inserted between the hinge column 94 a corresponding upper hinge housing 96, any manufacturing defects could mean that the doors 22, 24 do not rotate properly or do not shut completely when closed.

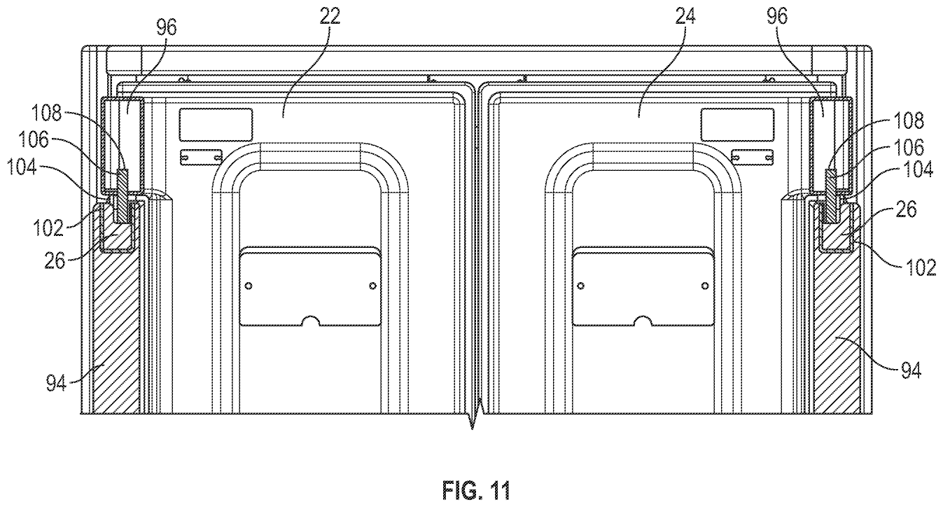

The current hinge 26 solves this issue by providing an adjustable means for coupling each of the doors 22, 24 to their respective hinge columns 94. In one embodiment, as the hinge column 94 of each respective side panel 18, 20 is being rotationally molded, an aperture or socket 102 is defined within a top facing surface 104 of the hinge column 94. The socket 102 in certain embodiments comprises an internal volume which matches or corresponds to the overall shape of the hinge 26. For example, the socket 102 defined in the hinge column 94 comprises a substantial decagonal shape so as to fit or accommodate each of the plurality of facets 86 of the hinge 26 in a substantially nested or fitted configuration. Once formed, the hinge 26 is inserted into the socket 102 by first placing the bottom surface of the hinge 26 into the socket 102 and then dropping or sliding the hinge 26 into the socket 102 at an initial position or orientation with the top surface 84 of the hinge 26 flush or exposed relative to the top facing surface 104 of the hinge column 94 as seen in the cross sectional view of FIG. 11.

Next, in one particular embodiment, a first lateral end of a hinge pin 106 seen in FIG. 11 is inserted into the bore 90 of the hinge 26. A second lateral end of the hinge pin 106 is then inserted into a correspondingly shaped hole 108 defined in the hinge housing 96 of the door 22, 24 which is to be coupled to the side panel 18, 20 in one embodiment by disposing the hole 108 directly over the hinge pin 106 that is extending upwards from the hinge column 94 and then moving the hinge housing 96 downward on top of the hinge pin 106 so that it enters the hole 108. In some embodiments, both the hinge pin 106 and the hole 108 comprise a substantially circular or semi-circular shape, and in one particular embodiment, the hinge pin 106 comprises a diameter of at least 3/8 inches. In a related embodiment, instead of first inserting the hinge pin 106 into the bore 90 of the hinge 26, the hinge pin 106 may be first inserted into the hole 108 defined within the hinge housing 96 so that that the door 22, 24 to be coupled may be placed and then locked into position by disposing the hinge housing 96/hinge pin 106 directly over the bore 90 defined within the hinge 26 and then inserting the hinge pin 106 therein. In certain other embodiments, the hinge housing 96 may instead comprises a peg or other protuberance integrally formed with the hinge housing 96 which may be directly inserted into the bore 90 of the hinge 26, thereby eliminating the need for a separate or additional hinge pin or component.

Once the door 22, 24 has been hung or coupled to the cart 10, the user may check the vertical position of the door 22, 24 and the ability of the door 22, 24 to rotate about the hinge column 94. If the door 22, 24 does not properly operate or is otherwise misaligned with the cart 10, the door 22, 24 is removed from the hinge 26 and the hinge 26 is then rotated relative to the socket 102 defined in the hinge column 94 in which it is disposed. Because the bore 90 defined in the hinge 26 is substantially off-center relative to the longitudinal axis 92 of the hinge 26, the position of the bore 90 is also rotated a corresponding amount. The user may then reinsert the hinge pin 106 and/or recouple the door 22, 24 to the hinge 26 with the bore 90 at a second or adjusted position, thereby disposing the door 22, 24 at a slightly different position and orientation relative the hinge column 94. If the door 22, 24 is still misaligned, the hinge 26 may again be repeatedly rotated within the socket 102 until a position for the bore 90 is found which in turn places the door 22, 24 in a proper vertical alignment with the hinge column 94 and the rest of the cart 10. Because the hinge 26 comprises a plurality of facets 86 which matches the cross sectional shape of the socket 102, relative rotational movement between the hinge 26 and the hinge column 94 and/or the hinge housing 96 is prevented. In other words, the facets 86 ensure that the hinge 26 remains stationary even when the door 22, 24 is actively being rotated open or closed.

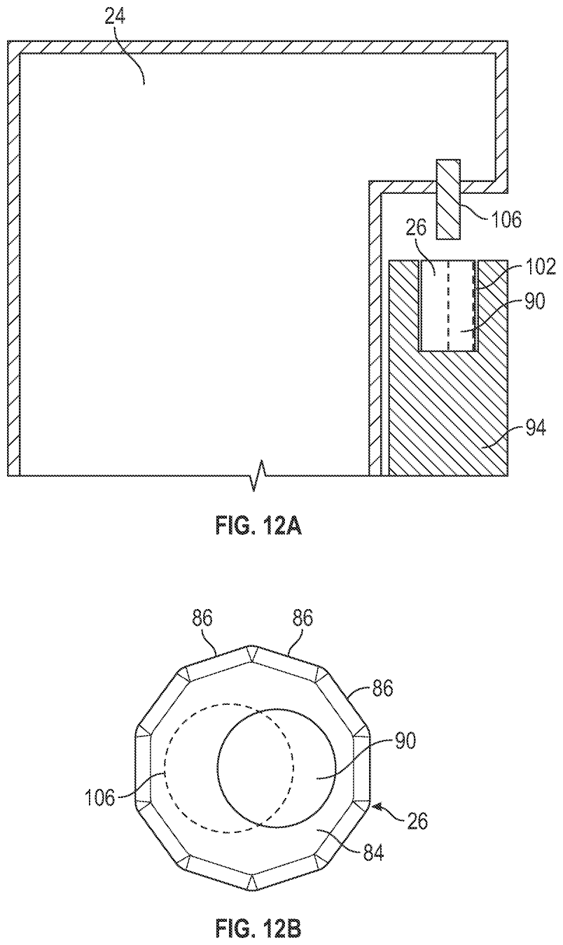

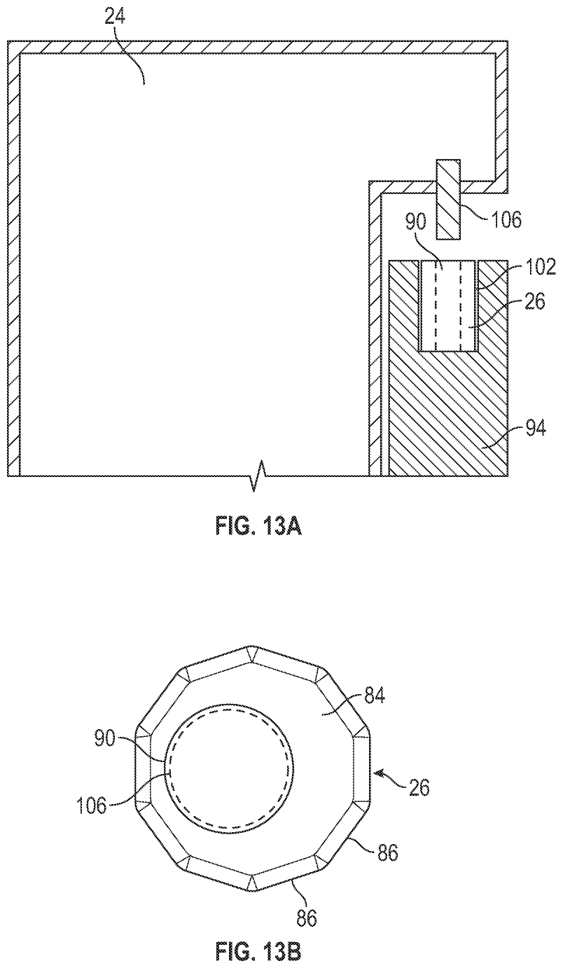

An conceptual illustration of a specific embodiment of how the hinge 26 may be adjusted to compensate for variations in the manufacturing process may be seen in FIGS. 12A-13B which illustrate the door 24, the hinge 26, and the hinge column 94 of cart 10. In FIG. 12A, the door 24 with the hinge pin 106 disposed therein is provided over the hinge column 94 so that the hinge pin 106 projects downward towards the hinge column 94. The hinge column 94 in turn accommodates the hinge 26 within its corresponding socket 102. Because of manufacturing inconsistencies associated with rotational molding, the resulting hinge pin 106 that is disposed in the door 24 may be misaligned with the bore 90 defined in the hinge 26, the bore 90 being seen in broken line within the hinge 26. In this particular example, the hinge 26 is disposed within the socket 102 such that the bore 90 is seen as being at a substantially right-handed or lateral portion of the hinge 26. FIG. 12B is a top down illustration of this occurrence, namely with the cross sectional shape of the hinge pin 106 being shown in broken line and only being partially or incompletely aligned with the bore 90 defined through the hinge 26. To correct the misalignment between the hinge pin 106 and the bore 90, the hinge 26 is rotated within the socket 102 so that the bore 90 is moved or rotated to the relative position seen in FIGS. 13A and 13B. More specifically, the hinge 26 is rotated so that the bore 90 is moved to a substantially left-handed or lateral portion of the hinge 26 seen in FIG. 13A so that a cross sectional center of the bore 90 is disposed directly beneath or otherwise aligned with a cross sectional center of the hinge pin 106. FIG. 13B, for example, shows that when the hinge 26 is properly aligned with the hinge pin 106, the cross sectional area of the hinge pin 106 shown by the broken line is entirely or completely enclosed or accommodated with the circular cross section of the bore 90. The door 24 is then coupled to the hinge column 94 of the cart 10 by then lowering or inserting the hinge pin 106 into the now currently aligned bore 90 of the hinge 26. It should be noted that in some embodiments the hinge 26 may be continually or repeatedly rotated within the socket 102 until alignment between the hinge pin 106 and the bore 90 has been achieved. With the hinge pin 106 inserted in the bore 90, the door 24 may be freely opened or closed relative to the cart 10 with the hinge pin 106 rotating within the bore 90 accordingly.

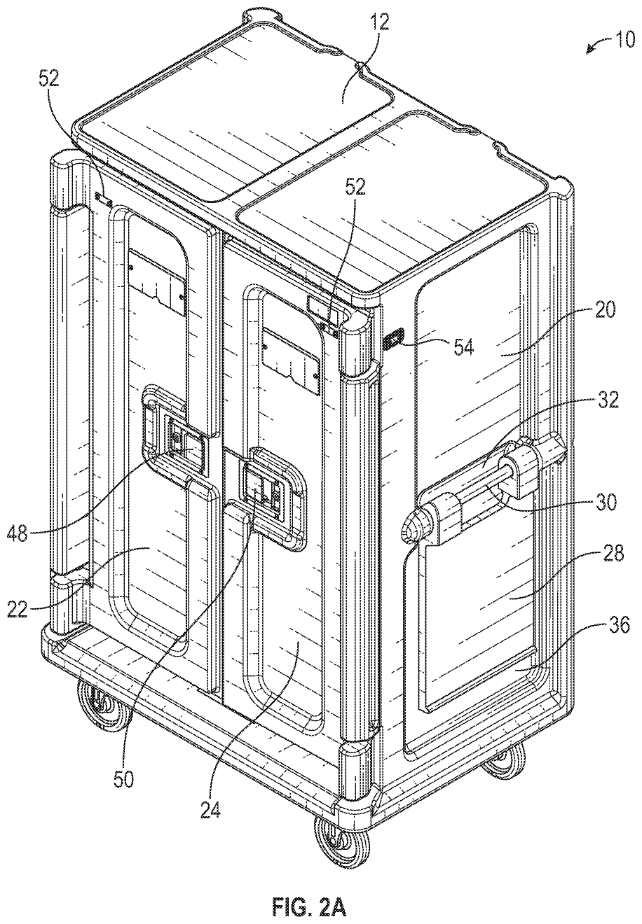

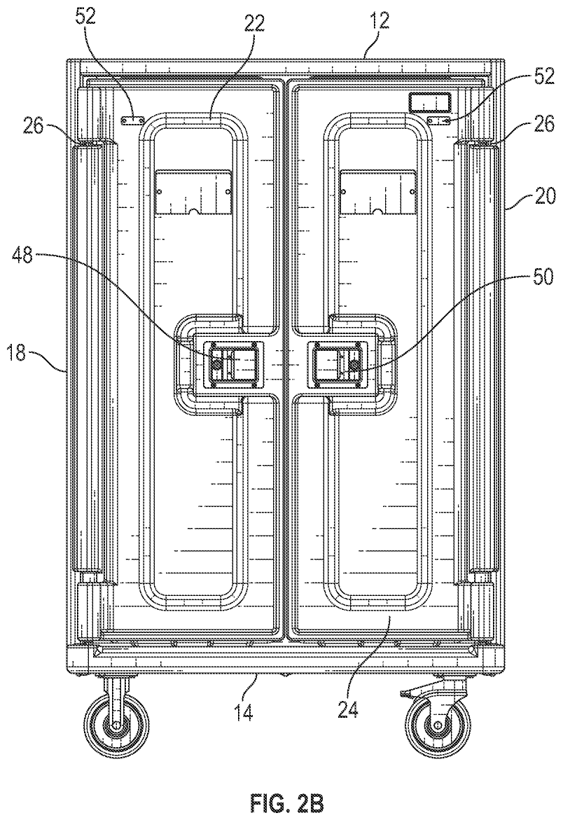

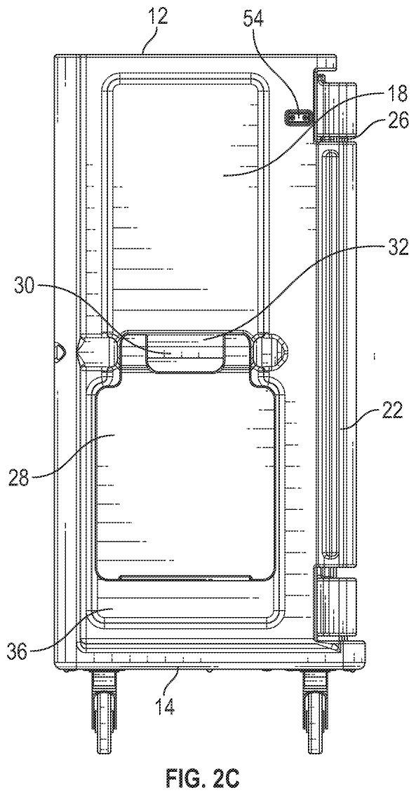

Returning to FIGS. 1A-1C, the cart 10 comprises a plurality of opening means or paddle latches, specifically a left-orientated paddle latch 48 disposed on the first door 22, and a right-orientated paddle latch 50 disposed on the second door 24. Also disposed on each of the first door 22 and second door 24 is a door magnet 52 that is set or defined into the front facing surface of each of the first door 22 and the second door 24. FIG. 1A shows each of the door magnets 52 as being disposed in the upper left or upper right corner of the first door 22 and second door 24, respectively, however it is to be expressly understood that the door magnets 52 may be disposed anywhere on or within the doors 22, 24 in further embodiments. As also seen in FIGS. 1A and 1C, a panel magnet 54 is disposed on or set within the surface of the second side panel 20, while FIG. 2C shows a corresponding panel 54 magnet disposed on or set within the surface of the first side panel 18. Both the door magnets 52 and the panel magnets 54 are preferably comprised of ferromagnetic material and are polarized or orientated to attract to one another when brought into close proximity with each other as discussed further below.

In a related embodiment, the cart 10 further comprises one or more pockets 56 disposed thereon. The pockets 56 are preferably comprised of plastic or other substantially transparent material and are preferably disposed on each of the first door 22 and the second door 24 or any other highly visible surface of the cart 10. The pockets 56 are sized to hold and display any object placed therein including but not limited to menus, business cards, advertising, and the like.

In one embodiment seen in FIGS. 1A-2C, the cart 10 further comprises a foldable or retractable platform or end table 28. The end table 28 is coupled to a hand hold or rail 30 that is disposed within a substantially cylindrical or concave shape 32 defined within a side panel 18, 20 of the cart 10. The hand rail 30 allows for a user to push, pull, otherwise manipulate the cart 10 using a plurality of casters 82 coupled to the bottom surface 14 of the cart 10. The side panel 18, 20 further comprises a substantially rectangular recess or indentation 36 which is sized to accommodate the substantially rectangular shape and relative thickness of the end table 28. While FIGS. 1A-1C show that the rail 30 and end table 28 are specifically coupled to the second side panel 20, it is to be expressly understood that the rail 30 and end table 28 may be coupled to the first side panel 18 instead of or in addition to the second side panel 20 in further embodiments.

In a further embodiment, a prop rod 34 is adjustably disposed between the side panel 20 and the end table 28 so as to maintain the end table 28 in a substantially horizontal or extended position that is perpendicular relative to the side panel 20 as best seen in FIGS. 1A-1D. The prop rod 34 is pivotably coupled to an end table bracket 40 with its free distal end configured to be inserted into a corresponding panel bracket 38 disposed within the recess 36 portion of the panel 20. To disengage the prop rod 34, the user removes the distal end or tip of the prop rod 34 from the panel bracket 38 and allows the end table 28 to rotate about the hand hold 30 in the downward direction against the vertical surface of the second panel 20. The user continues to rotate or pivot the end table 28 down and toward to the surface of the side panel 20 while the prop rod 34 simultaneously moves into a substantially cylindrically shaped rod indentation 42 defined in a bottom surface 46 of the end table 28. As the end table 28 rotates towards the side panel 20, it enters the defined cutout or recess 36 which is configured to accommodate or capture the end table 28 while the panel bracket 38 disposed within the recess 36 moves into or is inserted into a correspondingly shaped bracket definition or cutout 44 defined in the bottom surface 46 of the end table 28. With the prop rod 34 and panel bracket 38 nested or accommodated within the rod indentation 42 and bracket cutout 44 respectively, a flush or smooth surface is formed between the end table 28 and the rest of the cart 10 even when the end table 28 is in a final contracted or substantially vertical position as seen in FIGS. 2A-2C.

To expand or use the end table 28, a reverse method from the process described above is performed, namely with the user rotating the end table 28 about the rail 30 until the end table 28 is substantially perpendicular relative to the vertical surface of the second panel 20. As the end table 28 is rotated away from the recess 36, the bracket cutout 44 is moved away from the panel bracket 38 thereby exposing it to the user while the prop rod 34 falls away from the rod indentation 42 under gravity or, alternatively, the user may remove the prop rod 34 from the rod indentation 42. The user may then rotate the prop rod 34 about the end table bracket 40 and then insert the distal end of the prop rod 34 into the panel bracket 38, thereby propping up or maintaining the end table 28 in the expanded configuration seen in FIGS. 1A-1D. In a related alternative embodiment, the prop rod 34 may instead be rotatably coupled to the panel bracket 38 with its distal end then being configured for insertion into the end table bracket 40 after being removed from the rod indentation 42.

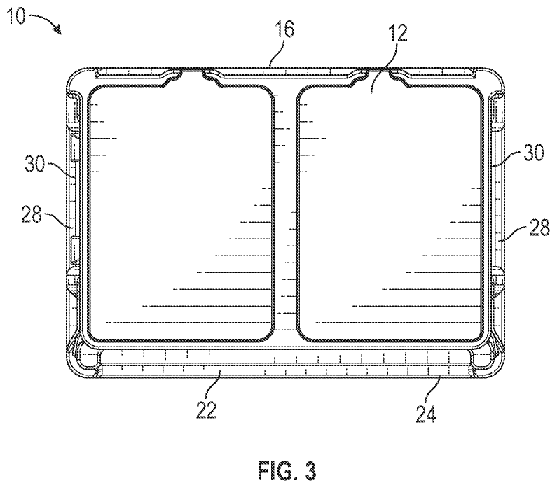

In a related embodiment seen in the top down view of FIG. 3, the cart 10 comprises a plurality of end tables 28, specifically an end table 28 disposed on both the first side panel 18 and the second side panel 20. Because the recesses 36 disposed in both side panels 18, 20 accommodate the respective end tables 28 as described above, the overall footprint or profile of the cart 10 is not increased or altered in any dimension when the end tables 28 are in the contracted or folded configuration as seen.

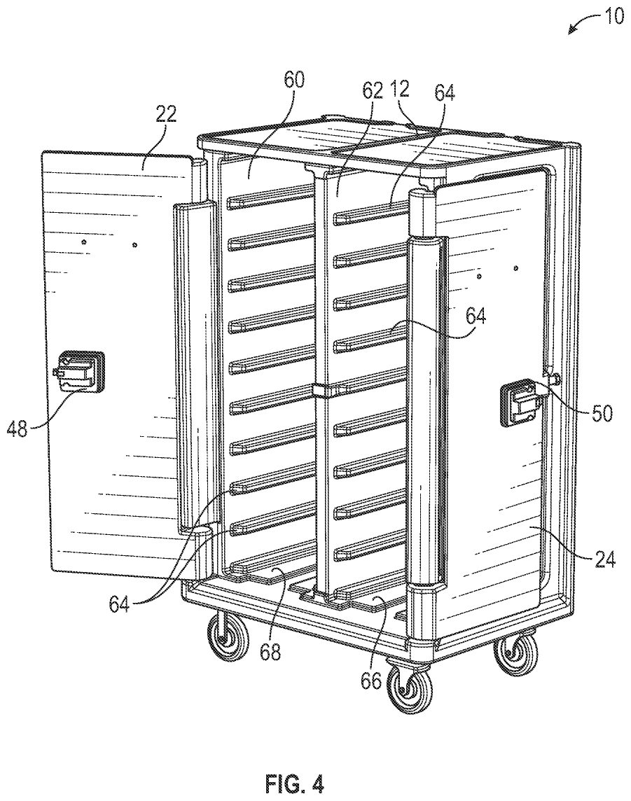

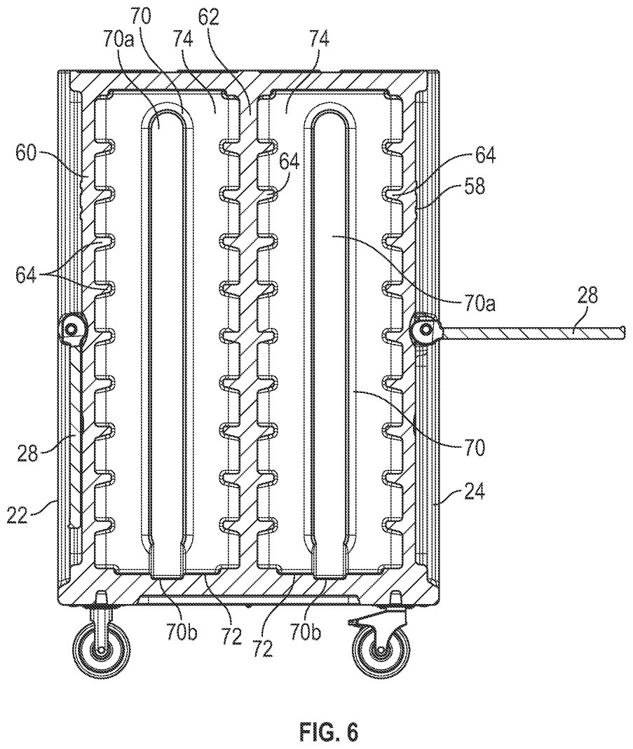

Greater understanding of the interior of the cart 10 and how the first and second doors 22, 24 operate may be seen in FIGS. 4-9. FIGS. 4-6 specifically show how the cart 10 comprises an interior space or volume defined by a pair of side walls 58, 60 disposed on either lateral end of the cart 10. A dividing wall or partition 62 is disposed across the width of the cart 10 at a substantially longitudinal mid or center point of the cart 10 that divides or bifurcates the interior space or volume into substantially equal halves or parts 66, 68. Both sides or surfaces of the dividing wall 62 and both side walls 58, 60 each comprise a plurality of tray supports 64 disposed thereon. In one embodiment, the plurality of tray supports 64 are configured to form a substantially mirror-image configuration with each tray support 64 disposed on the dividing wall 62 having a corresponding tray support 64 disposed on either of the side walls 58, 60 at the same relative height. In other words, each pair of tray supports 64 forms a bracket or shelf within each half or part 66, 68 so that when a tray or other item is to be inserted into the cart 10, the lateral ends of the tray may be placed upon or otherwise supported by the pair of tray supports 64 in a stable and substantially horizontal position thereon. The tray supports 64 are disposed along the height of each side wall 58, 60 as well as each opposing surface of the dividing wall 62 so that a plurality of trays or other items may be stored or accommodated within the cart 10 in a stacked configuration, namely with a stack or column of trays disposed in each half or part 66, 68.

In one embodiment, the interior surfaces of each half or part 66, 68 of the internal volume of the cart 10 comprises an indentation or flue 70. In one particular embodiment, the flue 70 comprises an upper portion 70a and a lower portion 70b defined in an inner rear wall surface 74 and an inner bottom surface 72, respectively. Because the flue 70 is recessed or defined within the inner surfaces 72, 74, a trough or negative volume is created which allows heat to more easily travel or move from a lower portion of the cart 10 to an upper portion of the cart 10. For example, heat radiating from any food items disposed on any of the trays disposed on a corresponding pair of tray supports 64, or any other means for providing or generating heat, will draw cooler air from outside the cart 10 into the interior volume where it begins to warm. The warmed air then travels vertically upward through the interior volume of the cart 10 via the lower portion 70b and/or the upper portion 70a of the flume 70 where it then begins to cool. In this fashion, the flume 70 helps establish a convection current through the interior of the cart 10.

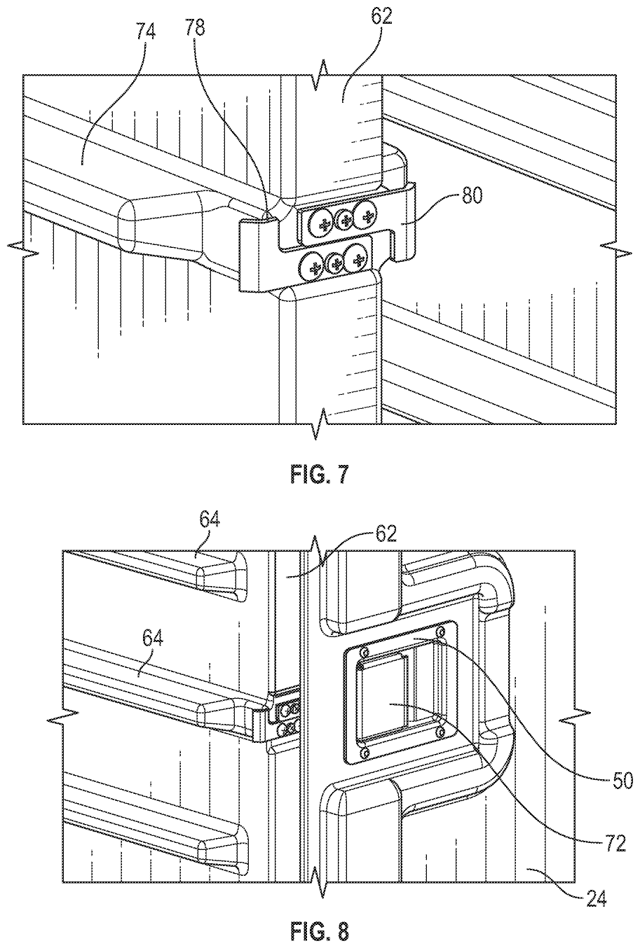

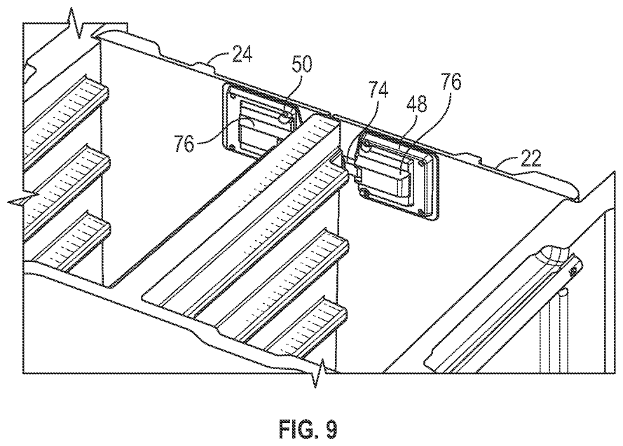

Greater detail of the paddle latches 48, 50 may be seen by turning to FIGS. 7-9. In one embodiment, each paddle latch 48, 50 comprises a paddle 72 disposed on a frontal or outer face of the latch 48, 50 which is coupled to a slidable or movable bolt 74 disposed on a rear of inner face of the latch 48, 50. A pair of left and right orientated strike plates 78, 80 are coupled to a front facing edge or surface of the dividing wall 62. To actuate each of the paddle latches 48, 50 and open either of the first door 22 or second door 24, a user actuates the paddle 72 which then retracts the bolt 74 into a housing 76 as best seen in FIG. 9. The bolt 74 continues to be retracted into the housing 76 until it clears the corresponding strike plate 78, 80 which then allows the doors 22, 24 to be swung open by rotating each door 22, 24 about its corresponding hinges 26.

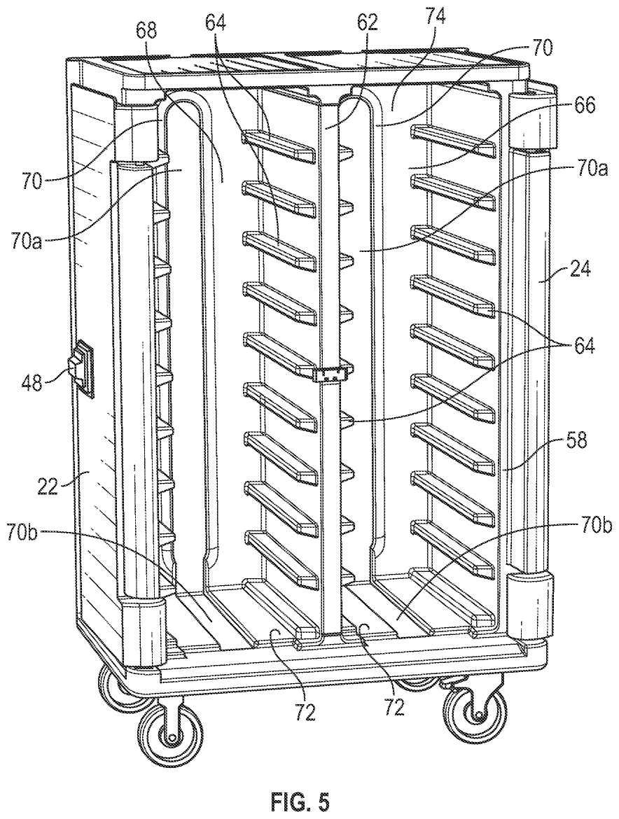

In one embodiment, once the first and second door 22, 24 have been opened, the user may continue to swing or rotate the doors 22, 24 open about their respective hinges 26 up to 270 degrees to their maximum open position or configuration as seen in FIG. 5 with each door 22, 24 being substantially flat or flush against the first and second side panels 18, 20, respectively. When the door 22, 24 is disposed in its maximum or completely open position, the door magnet 52 is naturally placed into close proximity with a corresponding panel magnet 54, thereby drawing or attracting the door magnet 52 and panel magnet 54 together and holding the door 22, 24 in a fixed position relative to the surface of the respective side panel 18, 20. In a related embodiment, when an end table 28 is the expanded or upright position, for example the end table as seen in FIG. 1A, the door 22, 24 may be still be rotated to a maximum position of 190 degrees before making contact with the end table 28.

To close the doors 22, 24, the user rotates the doors 22, 24 about their hinges 26 in an opposing direction toward the front of the cart 10. As each door 22, 24 is rotated inward, the bolt 74 disposed thereon is brought into contact with a corresponding strike plate 78, 80. Continued rotation of the doors 22, 24 pushes the bolt 74 across the strike plate 78, 80, which in turn compresses a spring or other biasing means disposed within the housing 76. The bolt 74 continues to traverse or slide across the surface of the strike plate 78, 80 until the bolt 74 then slides or moves beyond the lateral edge of the strike plate 78, 80, thereby allowing the spring to once again expand and push the bolt 74 beyond the edge of the strike plate 78, 80 and lock the door 22, 24 into place.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A food service cart comprising:
at least one side panel;
at least one door removably coupled to the at least one side panel; and
a removable hinge disposed between the at least one side panel and the at least one door,
wherein the hinge comprises a bore defined through a longitudinal length of the hinge which is off-center relative to a longitudinal axis of the hinge.

2. The food service cart of claim 1 wherein the hinge is rotatable relative to the at least one door and the at least one side panel.

3. The food service cart of claim 1 wherein the hinge comprises:
a top surface; and
a bottom surface joined to the top surface by a body,
wherein the body comprises a plurality of facets defined around an outer circumference of the body.

4. The food service cart of claim 3 wherein the bore defined through the longitudinal length of the hinge is defined through a longitudinal length of the body.

5. The food service cart of claim 3 further comprising a plurality of bevels disposed around the outer circumference of the body, wherein at least one of the plurality of bevels is disposed between at least two of the plurality of facets.

6. The food service cart of claim 3 wherein the plurality of facets are disposed along the entire longitudinal length of the body.

7. The food service cart of claim 1 wherein the bore is configured to accommodate a hinge pin therein.

8. The food service cart of claim 1 further comprising an expandable end table coupled to the at least one side panel, wherein the end table forms a flush surface with the at least one side panel when the end table is in a contracted position.

9. The food service cart of claim 8 wherein the end table comprises:
a first bracket; and
an adjustable prop rod coupled to the first bracket,
wherein the prop rod is configured to removably couple to a second bracket disposed on the at least one side panel.

10. The food service cart of claim 9 wherein the end table further comprises:
a rod indentation defined in a bottom surface of the end table; and
a bracket cutout defined in the bottom surface of the end table,
wherein the rod indentation is configured to accommodate the longitudinal length of the prop rod, and
wherein the bracket cutout is configured to accommodate the second bracket disposed on the at least one side panel.

11. The food service cart of claim 8 wherein the at least one side panel comprises a recess configured to accommodate a thickness of the end table in order to form the flush surface.

12. The food service cart of claim 1 further comprising:
a first magnet disposed on the at least one door; and
a second disposed on the at least one side panel,
wherein the first magnet engages the second magnet when the at least one door is disposed adjacent to the at least one side panel.

13. The food service cart of claim 8 wherein the at least one door is configured to open to a maximum of 270 degrees relative to a closed configuration when the end table is in the contracted position, and to a maximum of 190 degrees relative to the closed configuration when the end table is in an expanded configuration.

14. The food service cart of claim 1 further comprising an internal volume subdivided into a plurality of parts by a dividing wall disposed therein.

15. The food service cart of claim 14 further comprising a plurality of tray supports disposed on the dividing wall and on an inside surface of the at least one side panel.

16. The food service cart of claim 14 wherein each of the plurality of parts of the internal volume comprises a flume defined therein.

17. A method for coupling a door to a side panel, the method comprising:
providing at least one side panel and at least one door;
disposing an adjustable hinge on the at least one side panel;
adjusting an orientation of the hinge relative to the at least one side panel; and
coupling the at least one door to the hinge,
wherein adjusting the orientation of the hinge relative to the at least one side panel comprises adjusting a relative position of a bore defined through a longitudinal length of the hinge until a vertical alignment between the bore and the at least one door is obtained.

18. The method of claim 17 wherein adjusting the orientation of the hinge relative to the at least one side panel comprises rotating the hinge relative to the at least one side panel.

19. The method of claim 17 wherein disposing the adjustable hinge on the at least one side panel comprises inserting the hinge into a socket defined in the at least one side panel.

20. The method of claim 19 wherein inserting the hinge into a socket defined in the at least one side panel comprises matching a plurality of facets disposed on the hinge to a correspondingly shaped internal surface of the socket.

21. The method of claim 17 further comprising inserting a first lateral end of a hinge pin into the hinge and inserting a second lateral end of the hinge pin into the at least one door.

22. The method of claim 17 wherein providing at least one side panel and at least one door comprises rotationally molding both the at least one side panel and the at least one door.

23. The method of claim 18 wherein rotating the hinge relative to the at least one side panel comprises changing a horizontal position of a bore defined within the hinge relative to the at least one side panel.

24. The method of claim 23 wherein coupling the at least one door to the hinge comprises inserting the at least one door into the bore defined in the hinge.

25. The method of claim 17 further comprising:
providing at least one expandable end table coupled to the at least one side panel;
providing a plurality of tray supports within an internal volume of the food service cart; and
providing a flume defined within the internal volume of the food service cart.
